(19) United States
(12) Patent Application Publication
(10) Pub. No.: US 2025/0382051 A1
(43) Pub. Date: Dec. 18, 2025

(54) EMERGENCY FLOTATION SYSTEM AND AIRCRAFT WITH EMERGENCY FLOTATION SYSTEM

(71) Applicant: AIRBUS HELICOPTERS DEUTSCHLAND GMBH, Donauwörth (DE)

(72) Inventors: Bettar Ould EL MOCTAR, Hamburg (DE); Andreas PETERS, Düsseldorf (DE); Simon TÖDTER, Duisburg (DE)

(73) Assignee: AIRBUS HELICOPTERS DEUTSCHLAND GMBH, Donauwörth (DE)

(21) Appl. No.: 19/237,204

(22) Filed: Jun. 13, 2025

(30) Foreign Application Priority Data
Jun. 13, 2024 (DE) 102024116613.4

(51) Int. Cl. B64C 25/56; B64C 25/32; B64D 25/00

(52) U.S. Cl. CPC B64C 25/56; B64D 25/00; B64C 2025/325

(57) ABSTRACT

An emergency flotation system for aircraft that, in particular, may be attached to the landing gear or the fuselage of a helicopter, comprising at least two inflatable flotation bodies, each of which are extended in a direction of longitudinal extension and which are spaced apart in a horizontal direction transverse to, in particular, perpendicular to the direction of longitudinal extension, wherein the respective flotation bodies, when inflated, are cross-sectional shaped between their ends that is polygonal perpendicular to their direction of longitudinal extension. An aircraft, in particular, a helicopter, that has an emergency flotation system on its landing gear or fuselage, in particular, wherein the direction of longitudinal extension of the flotation bodies is orientated parallel to the axis of longitudinal extension or transverse, in particular, perpendicular, to the axis of longitudinal extension of the aircraft.

### CROSS-REFERENCE TO RELATED APPLICATION

This application claims priority to German patent application No. DE 102024116613.4 filed on Jun. 13, 2024, the disclosure of which is incorporated in its entirety by reference herein.

### TECHNICAL FIELD

The disclosure relates to an emergency flotation system for aircrafts that, in particular, may be attached to the landing gear or fuselage of an aircraft, preferably to a helicopter, comprising at least two inflatable flotation bodies, each of which are extended in a direction of longitudinal extension and which are spaced apart in a horizontal direction that is transverse, in particular, perpendicular, to the direction of longitudinal extension.

The flotation bodies feature said spacing in a horizontal direction at least in one position of use of the emergency flotation system when an aircraft with such an emergency flotation system is floating on a calm water surface. Unless otherwise specified, all directions refer to a position of use of the system on a calm water surface.

### BACKGROUND

The disclosure also relates to an aircraft, in particular, a helicopter, having such an emergency flotation system.

The approval criteria for helicopters have been significantly tightened with the entry into force of the European Union Aviation Safety Agency (EASA) Approval Directive CS-27 in 2021. Previously, to certify for worldwide use, it was necessary only to demonstrate that the helicopter floats stably in harmonic (regular) waves after making an emergency landing at sea using the attached emergency flotation system. The new regulations, in contrast, stipulate that the flotation stability in the seaway must be proven by model tests in irregular waves at sea state 6 for worldwide approval. The flotation stability may be considered to be proven if a capsizing probability of 3% with intact flotation bodies or 30% with a damaged flotation body is not exceeded.

Conventional emergency flotation systems have circular-cylindrical inflatable flotation bodies and do not have a sufficient probability of capsizing in the model test, insofar as such emergency flotation systems with circular-cylindrical-shaped flotation bodies when inflated are unlikely to be certifiable.

During studies, three basic steps of the capsizing process could be determined. In the first step, after an emergency landing utilising an emergency flotation system, the helicopter turns transversely to the incoming waves so that these waves hit the helicopter and the flotation bodies of the emergency flotation system laterally, i.e., in particular, transversely, relative to the respective longitudinal direction. Consequently, the helicopter begins to roll. If a breaking wave now hits the helicopter with the flotation bodies, the helicopter may capsize if the flotation bodies are not optimised for these scenarios, especially if they are circular-cylindrical-shaped as before.

Circular-cylindrical flotation bodies are known to not perform well when at sea. This applies, in particular, to dynamic stability in waves. There are numerous studies related to this, for example, those for submarines.

### SUMMARY

Thus, an object of the disclosure is to improve an emergency flotation system of said type such that it meets the requirements of the new approval directive and provides sufficient capsizing safety even in rough seas. Preferably, the object is to provide an emergency flotation system having improved dynamic properties in rough seas, in particular, in waves according to sea state 6, compared with circular-cylindrical-shaped flotation bodies.

According to the disclosure, this object is achieved by virtue of the fact that, when inflated, the respective flotation bodies have a polygonal cross-sectional shape between their ends, perpendicular to their direction of longitudinal extension. The object is further achieved by an aircraft, in particular, a helicopter, with such emergency flotation system, in particular, that has flotation bodies according to the disclosure.

Preferably, polygonal in terms of the disclosure does not mean a pointed angularity of the cross-section with straight edges in the mathematical sense, but rather an at least essentially polygonal configuration.

Due to the internal pressurisation of the flotation body, when inflated, the edges may be convexly bulged outwards when viewed in cross-section, and a rounded transition may be present in the corners of the flotation body between two such edges. Such an arrangement of a flotation body that has edges which are curved in cross-section, in particular, edges which are curved outwards, and has a rounded transition between such edges as a corner, is also understood to be angular in terms of the disclosure.

In particular, a rounded area in cross-sectional shape is defined as a corner opposite curved edges, when the radius of curvature of the rounded area is smaller than the radius of the curvature of a curved edge.

In particular, the cross-sectional shape must also be understood as angular in terms of the disclosure if curved edges which merge into one another via areas forming corners, the curvature radius of which is smaller than the curvature radius of the surrounding edges, may be approximated as straight lines by an averaged course and these approximated straight lines intersect. Such straight lines preferably enclose a rounded corner, preferably with the respective intersection of two such straight lines lying outside of a rounded corner.

The disclosure is advantageous in that in the event of dynamic movements of the emergency flotation system in rough seas, an aircraft equipped with such an emergency flotation system is more stable against capsizing than would be the case if it was equipped with an emergency flotation system which has conventional circular-cylindrical floats.

In particular, it was determined that an emergency flotation system according to the disclosure gives rise to a progression of the restoring torque over the roll angle that is improved for dynamic stability (compared with a circular-cylindrical flotation body of the same volume), and can thus prevent capsizing under more severe conditions. The emergency flotation system according to the disclosure preferably has, in further refinements, favourable slamming properties when subjected to the usual emergency water landing conditions described in the regulations.

In general, it is preferable that a polygonal cross-section is provided by using an angular basic shape, in particular, a triangle, quadrangle, preferably a rectangle, parallelogram, trapezium, equilateral n-angled shape, or by using shapes which are composed from these basic shapes. In terms of cross-sectional shapes composed of basic shapes, one of the basic shapes is preferably a triangle, rectangle or trapezium, preferably a basic shape of the composition located at the bottom in the position of use.

Preferably, the polygonal cross-section of a flotation body (when viewed perpendicular to the direction of longitudinal extension of the flotation bodies) is triangular or quadrangular. These are cross-sectional shapes which are easy to design and already have advantages over circular cross-sections.

Preferably, a preferred cross-sectional shape according to the disclosure is not rotation-symmetric, in particular, a cross-sectional shape according to the disclosure therefore only moves back onto itself upon a complete rotation through 360 degrees about a pivot point.

Preferably, the cross-sectional shape of a flotation body in the normal position of use on a calm water surface has an orientation wherein, with respect to the width of the cross-sectional shape when viewed horizontally, the area of the cross-sectional shape with the smaller, in particular, the smallest, width is located at the bottom.

In the quadrangular embodiment, a trapezoidal embodiment of the cross-section is preferred. More preferably, in the trapezoidal embodiment of the cross-section, it is intended that the shorter edge of two edges opposite one another in elevation is located at the bottom.

More preferably, in the trapezoidal embodiment of the cross-section, it is envisaged that the edges of a trapezoidal cross-section located opposite one another around a vertical line have different angular magnitudes relative to the vertical line. In particular, this means a different absolute angular magnitude without any regard to the sign of the angle. In particular, when rolling under rough sea conditions, the dynamic effect may be improved via different angles.

A preferred embodiment envisages that, in a horizontally aligned arrangement of the flotation bodies spaced apart in the cross-sectional shape of the flotation bodies when viewed perpendicular to the direction of longitudinal extension, an external edge, in particular, the outermost edge of the respective cross-section, encloses a greater angle with the vertical than an internal edge, in particular, the innermost edge.

As a result, the external lateral surface of the flotation body forms a smaller angle with the water surface than the internal lateral surface. This embodiment according to the disclosure thus generates a greater buoyancy gradient under dynamic immersion conditions than would be the case for a circular-cylindrical embodiment of the flotation body.

Alternatively or also cumulatively to said embodiment, it is also envisaged that the external and upper corner of the cross-section is located in a higher position than the internal and upper corner of the cross-section. During a rolling movement, the external lateral surface of the flotation body may thus take full effect over a greater depth of immersion.

Both said embodiments are advantageous in that, around the waterline, the width of the cross-section of a flotation body, when viewed horizontally, increases upwards, i.e., with increasing immersion depth. The mathematical derivation of the displaced volume according to the immersion depth or also according to the roll angle is thus positive for a greater immersion depth range or also for a greater roll angle range compared with a circular-cylindrical flotation body.

In a preferred embodiment, the disclosure envisages the flotation bodies to have an outward-facing lateral surface longitudinally between their ends and in elevation between a lower longitudinal edge and an upper longitudinal edge. In the associated cross-sectional shape, such longitudinal edges form corresponding upper and lower corners at the end of a lateral edge representing the lateral surface in the cross-sectional shape, in particular, wherein the surface normal applied externally to the lateral surface points away from the flotation body that surrounds this lateral surface, and preferably also points away from any other flotation body of the system.

When the system is loaded by the weight of an aircraft and calm water, the waterline preferably is located in the lateral surface, and/or between the lower and upper longitudinal edge of this lateral surface, and/or intersects the lateral edge when viewed in cross-section.

In this or other embodiments, the term “outwards” preferably means away from the emergency flotation system, preferably in a direction parallel to the spacing apart of the flotation bodies.

When viewing the emergency flotation system from outside (in particular, when viewing it in horizontal direction), a lateral surface is thus preferably visible between an upper and lower longitudinal edge of the flotation body, which is in an idealised manner supposed to be planar, eventually curved for technical reasons, in particular, however, the curvature of which is smaller than that of a circular-cylindrical flotation body of the same flotation body volume.

This is advantageous in that this lateral surface is exposed to breaking waves and counteracts a breaking wave with a large surface area, that leads to a wave pushing the emergency flotation system horizontally in front of it rather than setting it into a rolling movement or reinforcing it.

An advantage of this embodiment compared with a flotation body having a circular cross-section is preferably that, due to the lateral surface, in particular, the lateral surface that is in an idealised manner supposed to be planar, the force that a wave breaking onto the flotation body exerts on the flotation body indirectly distributed over the lateral surface, is always also split into a horizontal force component that is greater than would be the case for a circular cross-section, the effect of which is that the flotation body of the system according to the disclosure, together with the supported aircraft, is pushed horizontally in advance of the wave to a greater extent than would be the case for previous flotation bodies, irrespective of the direction wherein the wave impinges on the flotation body.

Preferably, the effect of which via the lateral surface is that the impact point of the wave-induced horizontal force is lower than compared with the circular-cylindrical flotation body with the same volume, thereby reducing the rolling torque.

In terms of a circular cross-section, in contrast, the wave-induced horizontal force acts for the most part on the surface of the aircraft above the flotation bodies, whereby the point of impact of this force is located further up. As a result, the impact rolling torque is greater. In contrast, this disadvantage is overcome along with the embodiment according to the disclosure.

Therein, it is particularly preferable that the lower and upper longitudinal edges of the lateral surface form the lowermost and uppermost longitudinal edges of the flotation body on the outside of the flotation body.

Preferably, this means that the respective flotation body in question has only one external lateral surface, particularly, when the flotation body is externally viewed horizontally. In particular, in this case, the term “externally” denotes the side facing away from the aircraft and/or all flotation bodies of a vertical plane that is preferably placed centrally via the flotation body and is located parallel to the longitudinal direction of the flotation body.

Said lateral surface is preferably orientated vertically, or is inclined outwards and downwards relative to a vertical plane that is parallel to the direction of longitudinal extension. In particular, in an aircraft-mounted system, the lateral surface thus has a normal vector that intersects the water surface and that has an outward-facing component.

Said orientations must in turn preferably be presumed to be given if the system is floating along with an aircraft on a calm water surface. Furthermore, this is advantageous in that when the aircraft rolls, such a lateral surface that rises above the water surface is rotated towards the vertical plane, whereby the effective surface area that is opposed to an incoming wave against the lateral surface is increased by the rolling movement compared to a position of the system on a calm water surface. The described positive effect of the flotation body relative to said horizontal pushing movement by an incoming wave is thus improved dynamically in rough seas.

In all possible embodiments and/or cross-sectional shapes of the flotation bodies, preference is given to those wherein the integral of the restoring torque over the roll angle is greater than the same integral for a system with flotation bodies of the same volume and a circular cross-sectional shape between the ends. This preferably applies at least in a predetermined roll angle range of 0 to 20 degrees, preferably 0 to 30 degrees, preferably 0 to 40 degrees, more preferably 0 to 50 degrees.

In all possible embodiments or cross-sectional shapes of the flotation bodies, preference is furthermore given to those wherein the restoring torque is greater than would be the case for a system with flotation bodies of the same volume and a circular cross-sectional shape between the ends, in particular, wherein the restoring torque is maximum at a roll angle that is greater than would be the case for a system with flotation bodies of the same volume and a circular cross-sectional shape between the ends. This preferably applies at least in a pre-determined roll angle range of 0 to 20 degrees, preferably 0 to 30 degrees, preferably 0 to 40 degrees, more preferably 0 to 50 degrees.

In particular, the cross-sectional shapes defined above, in particular, also those defined below, meet one or preferably all of these criteria.

Preferably, it is envisaged that the respective flotation body has, in an area above the centre of the body, a width, when viewed horizontally and perpendicular to the direction of longitudinal extension, that is greater than the width in the centre of the flotation body.

Preferably, as an alternative or also cumulatively to said embodiments, it is envisaged that the width, when viewed horizontally, of the cross-sectional shape of a flotation body with a given volume increases from bottom to top over a greater height, than would be the case for a flotation body with a circular cross-section of the same given volume.

This in turn means that the mathematical derivative of the water displacement according to the immersion depth (dV/dz) is positive for a larger interval of z compared to the circular-cylindrical flotation body shape.

Advantageously, the derivation of the water displacement according to the roll angle for a flotation body according to the disclosure (the one that is further immersed) is in turn positive for a greater roll angle range compared with the circular-cylindrical flotation body, in particular, positive for roll angles to at least 20 degrees, more preferably to at least 25 degrees, more preferably to at least 30 degrees, even more preferably to at least 35 degrees positive.

It is preferably envisaged that the width of the cross-sectional shape increases over more than 55%, preferably more than 60%, preferably more than 70%, preferably more than 80%, more preferably more than 90% of the total height of the respective cross-sectional shape.

In contrast, the width of a flotation body with a circular cross-sectional shape increases in a direction from bottom to top over exactly only 50% of the total height, specifically up to the horizontal central plane of the flotation body and subsequently decreases again.

It is further preferably envisaged that in rolling states wherein the flotation bodies spaced apart are tilted out of the horizontal position by a roll angle about a rolling axis lying centrally between them and parallel to the longitudinal extension, the cross-sectional dimension of the cross-sectional shape of one of the flotation bodies, when viewed perpendicular to the longitudinal extension, increases in the horizontal plane comprising the rolling axis or in the plane of the water line for increasing roll angles in an angular range from 0 degrees to at least 20 degrees, preferably 0 degrees to at least 25 degrees, more preferably 0 degrees to at least 30 degrees, still more preferably 0 degrees to at least 35 degrees.

A structurally preferred refinement envisages that the set of all flotation bodies forms two groups of flotation bodies, wherein both of the groups are spaced apart transversally, in particular, perpendicularly, to the direction of longitudinal extension of the flotation bodies, and each group of flotation bodies comprises at least two flotation bodies arranged one behind the other in the direction of longitudinal extension of the flotation bodies. Thus, the lift in the front and rear areas of an aircraft may be set differently. Furthermore, this also leads to the flotation bodies becoming redundant.

In such an embodiment, the cross-sections of the flotation bodies of the same group, when viewed perpendicular to the direction of longitudinal extension, may preferably have the same number of corners, but in particular, may have different shapes. Preferably, the cross-sectional area of the rear flotation body in flight direction is greater than the cross-sectional area of the front flotation body in flight direction. In this case, it may also be envisaged that the rear flotation bodies have a greater immersion depth than the front flotation bodies.

A refinement that may be combined with all possible embodiments preferably envisages that one end of the flotation body, in particular, an end of a flotation body that is at the front in flight direction, in particular, one of the flotation bodies that is at the front in said group in flight direction, forms a tip that protrudes from the flotation body, in particular, a tip that protrudes in flight direction.

Such a tip may be designed, for example, as a pyramid, in particular, with a pyramidal base that corresponds to the cross-sectional shape of the flotation body between its ends and with a pyramidal tip protruding from the base in flight direction.

In this case, as before, the body of the pyramid must not be understood in terms of mathematical precision, but preferably as an essentially pyramid-like body with curved surfaces and rounded corners.

Due to the pointed design, the impact loads (slamming) are reduced and the aerodynamics are improved prior to any emergency landing at sea. Preferably, it is envisaged that the part of the flotation body forming the tip, in particular, the pyramid, forms an inflatable partial flotation body of the flotation body, that has a volume separate from the remaining part of the flotation body.

In general, the disclosure may envisage that a respective flotation body comprises several inflatable partial flotation bodies. In such a case, the partial flotation bodies may form chambers, all of which are contained within an external casing of the flotation body having the described cross-sectional shapes. Alternatively, the individual partial flotation bodies may be formed without an external casing. In this case, an intended casing around the partial flotation bodies preferably corresponds to the cross-sectional shape as described above.

A further preferred embodiment envisages a respective flotation body to have stiffening structures and/or shaping structures, in particular, along the edges and/or along the lateral surfaces of the flotation body. Preferably, a respective flotation body may have struts and/or cables and/or internal surfaces and/or reinforcing seams running inside of it.

Thus, according to the disclosure, the inflated flotation body may be forced into the required external cross-sectional shape or a technically unavoidable curving of lateral surfaces (and/or in the cross-section of edges) or unavoidable rounding of longitudinal edges and/or in the cross-section of corners may be reduced.

For example, it may be envisaged that the structures and/or shaping structures are present in a collapsed state, in particular, a folded state, when the respective flotation body is uninflated and are present in an expanded state, in particular, an unfolded state, when inflated.

Inflation may take place in all possible embodiments, e.g., from a gas supply carried in the system and/or the aircraft.

For example, stiffening struts or shaping struts may each be formed from at least two or more partial struts which have a self-locking articulated connection. Due to the movement of the partial struts during the process of inflating a flotation body, they may take up a position wherein the automatic locking of the articulated connection is produced. Starting from this state, the struts form structures which define and/or stiffen the shape of the flotation body.

Shaping structures may also be formed, for example, by a cable arrangement or internal surface arrangement wherein, in the expanded state, several cable sections/internal surfaces are attached by one end to surfaces and/or edge areas or other stiffening structures/shaping structures of the flotation body, in particular, in the circumferential direction along the cross-sectional shape, and are interconnected by another end in a common attachment area. Such cable sections/internal surfaces of a cable arrangement/internal surface arrangement located inside of the cross-section thus also limit how far the lateral surfaces and/or longitudinal edges of the flotation body may expand during inflation.

In the case of an aircraft with such an emergency flotation system, a possible refinement may also envisage that the position of the emergency flotation system relative to the aircraft may be changed, in particular, during flight, preferably the emergency flotation system may be rotated about a vertical axis relative to the aircraft. Provided that an aircraft, such as a helicopter, does not approach the water surface exactly in straight flight in the event of an unavoidable crash, the emergency flotation system may be aligned so that the longitudinal direction of the flotation bodies coincides with the direction of the crash.

### BRIEF DESCRIPTION OF THE DRAWINGS

The disclosure and its advantages appear in greater detail in the context of the following description of embodiments given by way of illustration and with reference to the accompanying figures, wherein:

FIG. 1 shows an emergency flotation system on a helicopter according to the prior art;

FIGS. 2a to 2c show various views of a first possible embodiment of an emergency flotation system according to the disclosure with flotation bodies 2 on a helicopter shown as aircraft 1;

FIGS. 3a to 3c show the features as described in FIGS. 2a-2c, that the ends of the flotation bodies 2a which are at the front in flight direction have a tip 5 that protrudes in flight direction;

FIGS. 4a to 4b show the situation with a calm water surface when the flotation bodies 2a, 2b according to FIG. 4A are located next to one another in a horizontal arrangement and according to FIG. 4B when the aircraft 1 is tilted out of the horizontal position by a roll angle, such that the flotation body 2a, 2b shown, in this case, on the left is immersed into the water;

FIG. 5 shows shows a further alternative embodiment of the flotation bodies 2a, 2b;

FIG. 6 shows a further alternative embodiment of the flotation bodies 2a, 2b;

FIG. 7 shows a comparison of the restoring torques generated as a function of the roll angles for two different flotation bodies with the same volume, in this case, a trapezoidal cross-section according to the disclosure (dashed line) in comparison with the circular cross-section (solid line); and

FIG. 8 shows a cross-section of the floating body 2 in FIG. 2 to show one way of ensuring that the required cross-sectional shape is as angular as possible with at least essentially straight edges. For this purpose, the flotation body has shaping structures and/or stiffening structures in its interior.

### DETAILED DESCRIPTION

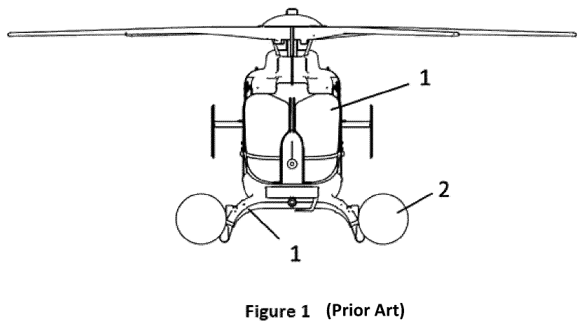

FIG. 1 shows, as a comparison with the disclosure, an emergency flotation system according to the prior art on a helicopter as an example of an aircraft 1. In this case, the emergency flotation system comprises two flotation bodies 2, which are horizontally spaced apart and attached to the landing gear 1a of the aircraft 1. In this case, it is envisaged that the flotation bodies 2 of the system are carried along in an uninflated state during normal flight operation and, for example, the flotation bodies 2 are inflated only in an emergency if the aircraft 1 has to land on water in an emergency. In this case, it is envisaged that the flotation bodies 2 of the system provide sufficient lift to the aircraft 1 so that it floats safely. These features of the prior art also apply to the disclosure described below.

According to the known prior art, the flotation bodies 2—as shown—are designed as circular-cylindrical longitudinally extended bodies and thus have a circular shape when viewed in cross-section perpendicular to the longitudinal axis, as shown in FIG. 1.

Although such flotation bodies 2 provide sufficient buoyancy in calm water, in waves which result in a rolling aircraft 1, these types of flotation bodies 2 however do not generate enough restoring energy to prevent the aircraft 1 from capsizing.

From an immersion depth of 50% of the entire height of the flotation body 2, the buoyancy still increases in absolute terms, but the mathematical derivation of the water displacement is negative from a roll angle that presses the immersion flotation body to more than 50% of its total height under water, in particular, this means that the relative increase in buoyancy and thus the relative increase in a resulting restoring torque from an immersion depth of 50% becomes negative. In waves, in particular, at sea state 6, it is not possible to effectively prevent capsizing, because, in terms of dynamic stability, the flotation bodies have comparatively rather negative properties.

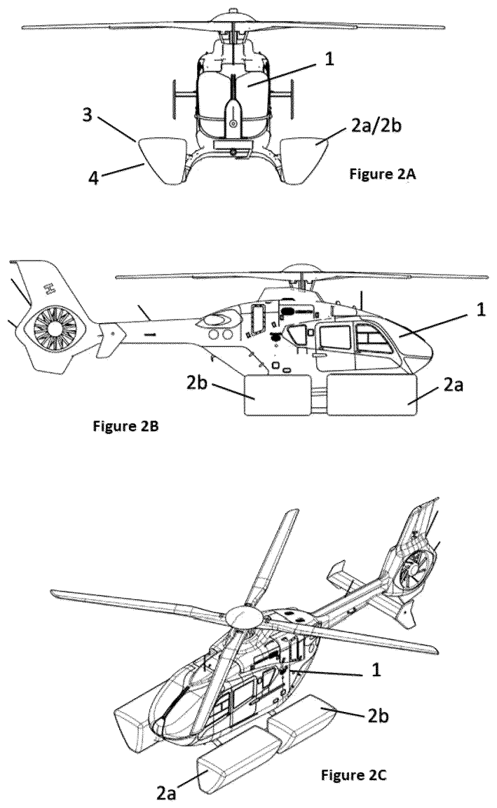

FIGS. 2A to 2C show various views of a first possible embodiment of an emergency flotation system according to the disclosure with flotation bodies 2 on a helicopter shown as aircraft 1.

The flotation bodies 2 are in turn spaced apart horizontally and form groups of two flotation bodies 2a and 2b each, which are arranged successively in the direction of the longitudinal extent of the flotation bodies 2a/2b and/or in the direction of the longitudinal axis of the aircraft 1, in particular, at a distance, on both sides of a vertical plane through the helicopter, in particular, which comprises the longitudinal axis of the helicopter.

The arrangement may be present in this way in all possible embodiments, in particular, those which are shown below, but also without a distance between the flotation bodies 2a, 2b of a group and/or also with more than two flotation bodies and/or also with only one flotation body on each side of the vertical plane, and/or on each runner of the landing gear.

In this first embodiment according to the disclosure, the flotation bodies 2a, 2b have a quadrangular cross-section when viewed perpendicular to the direction of longitudinal extension of the flotation bodies 2a, 2b between their respective ends.

The diagrams in FIGS. 1A-1C show that quadrangular must not be understood in the mathematical sense, because the four corners 3 are each rounded and the edges 4 curve outwards. This results, on the one hand, from a manufacturing perspective and/or via the internal pressurisation of the respective flotation body 2a, 2b with a filling gas.

In this embodiment, the quadrangular cross-sectional shape is trapezoidal, wherein the part of the cross-sectional shape with the width that is smaller horizontally at the bottom, and/or of the two edges 4 which are spaced apart in elevation, the shorter one is located at the bottom.

The cross-sectional shape is moreover such that the lateral surfaces/edges 4 spaced apart horizontally have different angular magnitudes relative to the vertical or also relative to the horizontal. In particular, the external lateral surface thereby adopts a smaller angle to the horizontal plane, that also corresponds to the water line, than the internal lateral surface/edge. In the case of a rolling movement, the external surface thus has a greater buoyancy gradient when immersed in the water during immersion than would be the case for a circular-cylindrical external surface that is immersed almost tangentially to the lateral surface.

In the case of a dynamic rolling movement of the flotation bodies 2 with a moving water surface, an emergency flotation system according to the disclosure will thus realise an advantage beyond mere buoyancy, that leads to a greater restoring torque than would be the case for a circular-cylindrical flotation body with the same volume.

In contrast, upon an emerging movement, the same flotation body 2 will rotate the external lateral surface/edge 4 towards the vertical such that the lateral surface effectively that is directed against a laterally incoming wave is enlarged by the rolling movement and is realised such that the incoming wave exerts a laterally horizontal pushing effect on the emergency flotation body system instead of pushing the flotation body down and reinforcing the rolling movement. This flotation body shaped according to the disclosure thus has clear advantages over a circular-cylindrical flotation body of the same volume when rolling both in the immersing phase and emerging phase.

In the diagrams in FIGS. 2, the flotation bodies have flat end surfaces at the front, i.e., at the front in flight direction.

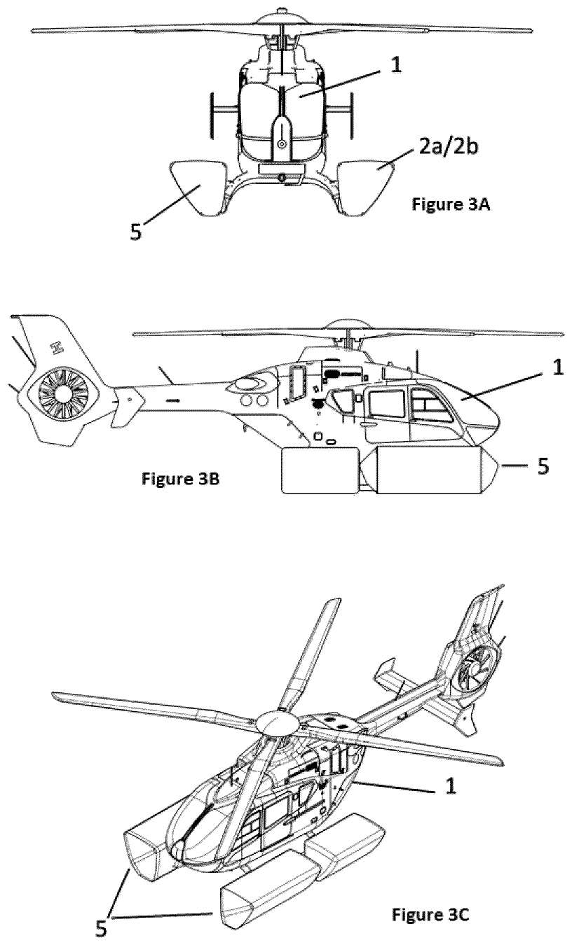

In contrast, FIGS. 3A to 3C show, with otherwise the same features as described in FIGS. 2, that the ends of the flotation bodies 2a which are at the front in flight direction have a tip 5 that protrudes in flight direction, the tip in this embodiment is formed by a pyramid shape whose base corresponds to the cross-sectional shape of the flotation body 2a between the ends. The pyramid shape is also formed with rounded tips or edges, such that even this pyramid shape must not be understood strictly mathematically.

This tapering of the front end in flight direction favours improved contact with the water surface in the event of a crash, combined with low impact loads and better aerodynamics, compared with the flat end surface of FIG. 2.

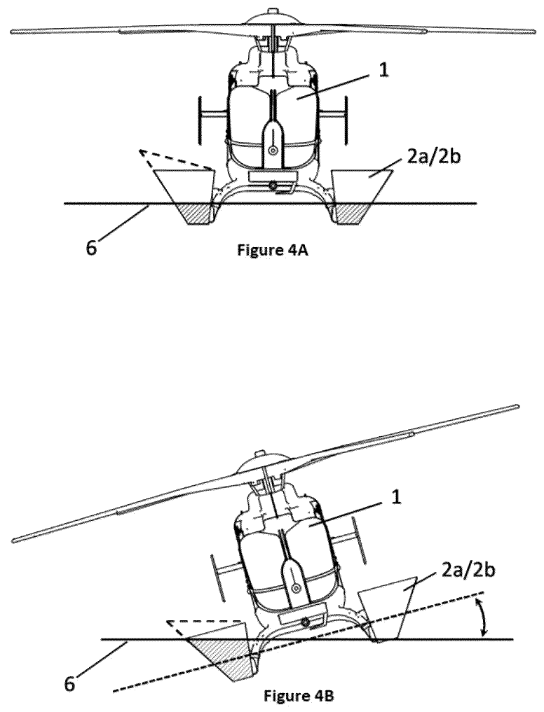

FIGS. 4A and 4B show the situation with a calm water surface when the flotation bodies 2a, 2b according to FIG. 4A are located next to one another in a horizontal arrangement and according to FIG. 4B when the aircraft 1 is tilted out of the horizontal position by a roll angle, such that the flotation body 2a, 2b shown, in this case, on the left is immersed into the water.

The water line 6 and the hatched areas of displaced water shown in cross-section clearly show further advantages of the emergency flotation system according to the disclosure.

In this case, it can thus be seen that the width of the cross-sectional shape when viewed horizontally increases around the water line 6, in particular, over a height above the water line 6, that corresponds at least to the height below the water line 6 when the calm water surface/roll angle is zero degrees as shown in FIG. 4A. This preferably applies to both the cross-sectional shape shown, in this case, and also to all cross-sectional shapes possible according to the disclosure.

The width, in this case, increases up to the roll angle shown in FIG. 4B, in particular, a roll angle of at least 20 degrees. At this roll angle, the horizontal width of a flotation body, as shown in FIG. 1, that is circular in cross-section, would decrease from an immersion of more than 50% of its total height.

This increase in width up to a maximum roll angle, that is greater than for a flotation body of the same volume with a circular cross-section, means that the mathematical derivation of the water displacement or also of the restoring torque according to the immersion depth or also according to the roll angle up to a greater roll angle is greater and/or positive compared to the flotation body of the same volume with a circular cross-section. Overall, the disclosure thus also realises a comparatively greater restoring operation (the integral of the restoring torque over the roll angle), clearly demonstrating the advantages of the disclosure.

By virtue of to the optional embodiment shown by dashed lines, wherein the external upper corner or longitudinal edge of a flotation body 2a/2b is raised above the internal upper corner/longitudinal edge in the horizontal position as shown in FIG. 4A, the maximum roll angle may still be raised significantly above that shown in FIG. 4B without having to significantly increase the volume of the flotation body 2a, 2b.

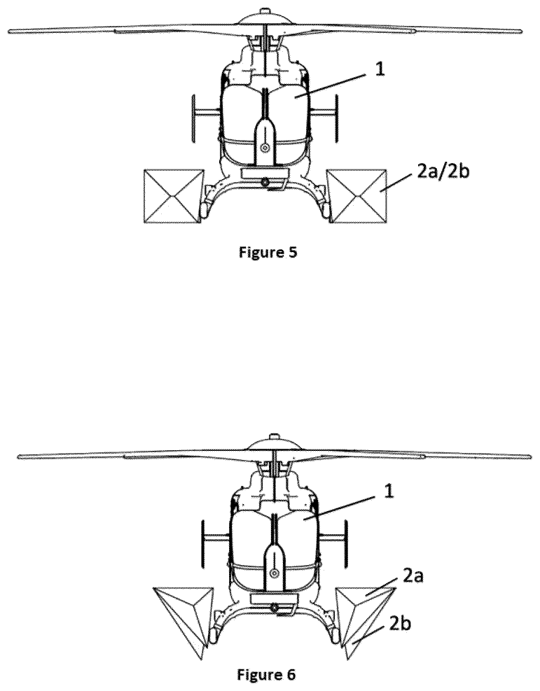

FIG. 5 shows a further alternative embodiment of the flotation bodies 2a, 2b. In this embodiment, the cross-sectional shape is also quadrangular, with different angles of inclination of the horizontally-spaced lateral surfaces/edges 4. In this case, the cross-sectional shape is mathematically simplified, i.e., shown with pointed corners and straight edges and corresponds to a trapezium approximating a square. In this case, the shorter of the vertically opposite edges is located at the bottom. However, even a square shape with vertical and horizontal edges would provide the described advantages compared with a circular cross-sectional shape. In this case, the front ends of the flotation bodies 2a, 2b are also preferably tapered.

FIG. 6 shows a further alternative embodiment of the flotation bodies 2a, 2b. In this embodiment, the cross-sectional shape is triangular that also results in different angles of inclination of the horizontally-spaced lateral surfaces/edges 4, because the triangular shape is orientated with its tip downwards. In this case, the cross-sectional shape is mathematically) simplified, i.e., shown with pointed corners and straight edges. Moreover, this shape produces the described advantages over the circular cross-sectional shape. In this case, the front ends of the flotation bodies 2a, 2b are also preferably tapered.

Furthermore, FIG. 6 shows that the rear flotation bodies 2b may have a different cross-sectional size than the front flotation bodies 2a, in particular, a larger one, in particular, also immersing deeper, with the same number of corners of the cross-sectional shape.

This applies to both a triangular cross-section, and also may be provided for any cross-sectional shape that is possible according to the disclosure.

Although not shown, in all possible embodiments, the disclosure may envisage that the cross-sections of the front and rear flotation bodies may also be different with respect to the number of corners.

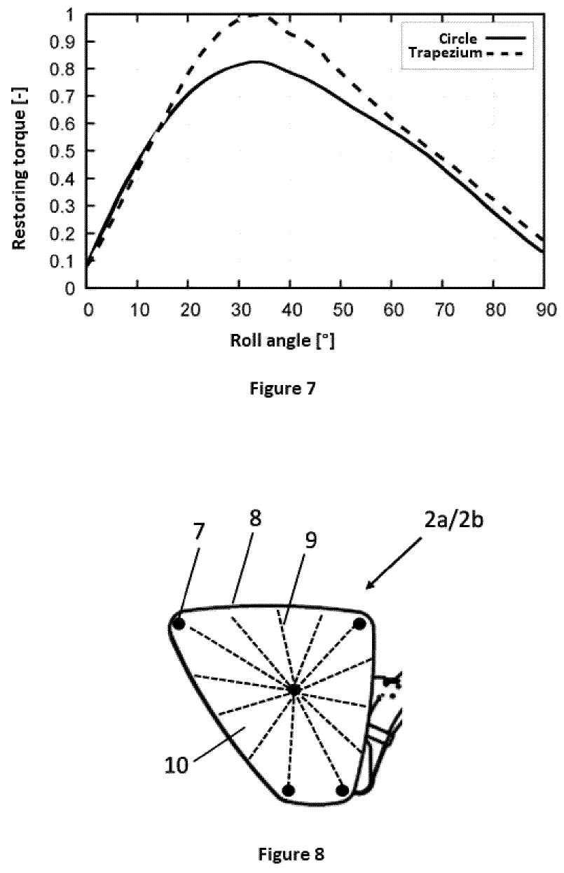

FIG. 7 shows a comparison of the restoring torques generated as a function of the roll angles for two different flotation bodies with the same volume, in this case, a trapezoidal cross-section according to the disclosure (dashed line) in comparison with the circular cross-section (solid line). It can be seen that a significantly greater restoring torque may be generated with the disclosure. The disclosure may preferably also ensure that the maximum of the restoring torque is both absolutely greater and also generated at a higher roll angle compared with the circular cross-section. The diagram further shows that the integral of the restoring torque over the roll angle is greater in the disclosure.

FIG. 8 shows a cross-section of the floating body 2 in FIG. 2 to show one way of ensuring that the required cross-sectional shape is as angular as possible with at least essentially straight edges. For this purpose, the flotation body has shaping structures and/or stiffening structures in its interior. In this case, these are preferably provided by struts 7 running longitudinally, which preferably are located in the longitudinal edges which are to be defined.

The relative position of the struts 7 and areas 8 in the lateral surfaces relative to one another may be realised by the cable sections 9, shown by dashed lines, which extend from a common attachment area, that may be provided by a strut that runs along longitudinally, or else by a further cable section extending longitudinally, in the direction outwards to the struts 7 or lateral surface areas 8 with a shape-defining length. Such a shaping structure is collapsible and defines, in a structurally simple manner, the shape when the flotation body is inflated 2a, 2b, because the outward extension of the flotation body 2a, 2b is limited by the cable sections 9.

The shaping and/or stiffening structure thus realised may preferably be arranged completely inside a flotation body.

The shaping structures, in particular, in this case, the lines, may alternatively also represent internal surfaces of the flotation body extending longitudinally and radially outwards from the common attachment area, which are attached at the radially external end to the lateral surfaces and/or longitudinal edges and/or struts, and are interconnected at the other radial end in a common attachment area, via which individual inflatable chambers extending longitudinally are separated from one another. This embodiment has an identical shaping effect and guarantees greater reliability of the flotation body.

What is claimed is:

1. An emergency flotation system for aircrafts that, in particular, may be attached to the landing gear or fuselage of a helicopter, comprising at least two inflatable flotation bodies, each of which are extended in a direction of longitudinal extension and which are spaced apart in a horizontal direction transverse, in particular, perpendicular, to the direction of longitudinal extension, wherein the respective flotation bodies comprise, when inflated, a polygonal cross-sectional shape between their ends, perpendicular to their direction of longitudinal extension.

2. The system according to claim 1, wherein the cross-sectional shape is triangular or quadrangular, preferably trapezoidal, more preferably wherein the edges of a trapezoidal cross-section which lie opposite one another around a vertical line comprise a different angular magnitude relative to the vertical line.

3. The system according to claim 2, wherein, in a horizontally oriented arrangement of the flotation bodies spaced apart in the cross-sectional shape of the flotation bodies when viewed perpendicular to the direction of longitudinal extension comprises:
an outer edge, in particular, the outermost edge of the respective cross-section, defines a greater angle with the vertical than an inner edge, in particular, the innermost edge; and/or
the external and upper corner of the cross-section is in a higher position than the internal and upper corner of the cross-section.

4. The system according to claim 1, wherein the flotation bodies comprise an outward-facing lateral surface in the direction of longitudinal extension between their ends and in elevation between a lower longitudinal edge and an upper longitudinal edge, in particular, wherein, in the event of loading of the system by an aircraft, the water line lies between the lower and upper longitudinal edge of this lateral surface.

5. The system according to claim 4, wherein the lower and upper longitudinal edges of the lateral surface on the outside of the flotation body form the lowermost and uppermost longitudinal edges of the flotation body.

6. The system according to claim 4, wherein the lateral surface is orientated vertically or is inclined outwards and downwards relative to a vertical plane that is parallel to the direction of longitudinal extension.

7. The system according to claim 1, wherein the integral of the restoring torque over the roll angle, in particular during dynamic rolling movements, is greater than the same integral in a system with flotation devices of the same volume and a circular cross-sectional shape between the ends.

8. The system according to claim 1, wherein the restoring torque, in particular during dynamic rolling movements, is greater than would be the case for a system with flotation bodies with the same volume and a circular cross-sectional shape between the ends, in particular, the restoring torque is at its maximum at a roll angle that is greater than would be the case for a system with flotation bodies of the same volume and a circular cross-sectional shape between the ends.

9. The system according to claim 1, wherein the respective flotation body comprises, in an area above the centre of the body, a width, when viewed horizontally and perpendicular to the direction of longitudinal extension, that is greater than the width in the centre of the flotation body.

10. The system according to claim 1, wherein the width, when viewed horizontally, of the cross-sectional shape of a flotation body with a given volume increases from bottom to top over a greater height, than would be the case for a flotation body with a circular cross-section of the same given volume.

11. The system according to claim 1, wherein the width of the cross-sectional shape increases over more than 55%, preferably more than 60%, preferably more than 70%, preferably more than 80%, more preferably more than 90% of the total height of the respective cross-sectional shape.

12. The system according to claim 1, wherein in rolling states wherein the flotation bodies spaced apart are tilted out of the horizontal position by a roll angle about a rolling axis lying centrally between them and parallel to the longitudinal extension, the cross-sectional dimension of the cross-sectional shape of one of the flotation bodies, when viewed perpendicular to the longitudinal extension, increases: in the horizontal plane comprising the rolling axis for increasing roll angles in the angular range from 0 degrees to at least 20 degrees, preferably 0 degrees to at least 35 degrees, more preferably 0 degrees to at least 40 degrees, still more preferably 0 degrees to at least 50 degrees.

13. The system according to claim 1, wherein all of the flotation bodies form two groups of flotation bodies, wherein both of the groups are spaced apart transversally, in particular, perpendicularly, to the direction of longitudinal extension, and each group of flotation bodies comprises at least two flotation bodies arranged longitudinally one behind one other.

14. The system according to claim 13, wherein the cross-sections of the flotation bodies of the same group, when viewed perpendicular to the longitudinal direction, comprises the same number of corners, but, in particular, are different in shape, and preferably the cross-sectional area of the rear flotation bodies in flight direction is greater than the cross-sectional area of the front flotation bodies in flight direction.

15. The system according to claim 13, wherein one end of the flotation body, in particular, a front end in flight direction of a flotation body, in particular, of a flotation body lying in front in flight direction in a group, forms a tip projecting from the flotation body, in particular, is designed as a pyramid, in particular, with a pyramidal base that corresponds to the cross-sectional shape of the flotation body between its ends and with a pyramidal tip projecting from the base in flight direction.

16. The system according to claim 1, wherein a respective flotation body comprises several inflatable partial flotation bodies.

17. The system according to claim 1, wherein a respective flotation body comprises stiffening structures and/or shaping structures, in particular, along the edges and/or along the lateral surfaces of the flotation body, preferably a respective flotation body comprises struts and/or cables and/or reinforcing seams and/or internal surfaces running throughout its interior.

18. The system according to claim 17, wherein the stiffening structures and/or shaping structures are present in a collapsed state, in particular, a folded state, when the respective flotation body is uninflated and are present in an expanded state, in particular, an unfolded state, when inflated.

19. The system according to claim 17, wherein stiffening struts or shaping struts are formed from partial struts which comprise a self-locking articulated connection or shaping structures form a cable arrangement or an internal surface arrangement wherein, when expanded, several cable sections and/or internal surfaces are attached by one end to surfaces and/or edge areas of the flotation body, in particular, in the circumferential direction along the cross-sectional shape, and are interconnected by another end in a common attachment area.

20. An aircraft, in particular a helicopter, comprising an emergency flotation system according to claim 1, on its landing gear or fuselage, in particular, wherein the direction of longitudinal extension of the flotation bodies is orientated in parallel to the axis of longitudinal extension or transversally, in particular, perpendicularly, to the axis of longitudinal extension of the aircraft.

21. The aircraft according to claim 20, wherein the position of the emergency flotation system relative to the aircraft may be changed, in particular, during flight, preferably the emergency flotation system may be rotated about a vertical axis relative to the aircraft.
